(19) United States
(12) Patent Application Publication
(10) Pub. No.: US 2017/0047158 A1
(43) Pub. Date: Feb. 16, 2017

(54) MAGNETIC MEMBER AND MANUFACTURING METHOD OF THE SAME

(71) Applicant: MAG.LAYERS Scientific-Technics Co., Ltd., Hsinchu County (TW)

(72) Inventors: Ching-Yuan Cheng, Pingzhen City (TW); Shih-Peng Liang, Taoyuan City (TW)

(21) Appl. No.: 14/962,601

(22) Filed: Dec. 8, 2015

(30) Foreign Application Priority Data
Aug. 12, 2015 (TW) 104212996

(51) Int. Cl. H01F 27/28; H01F 41/04

(52) U.S. Cl. CPC H01F 27/2804; H01F 41/041

(57) ABSTRACT

A magnetic member and its manufacturing method is provided, comprising a substrate, a circuit board, a magnetic element and a cover body, wherein the magnetic element is electrically connected to the circuit board quickly by surface mount technique so as to reduce occurrence of wire break. Furthermore, it is beneficial not only to slim type design of the magnetic member but also to the acceleration of manufacturing process speed of the magnetic member.

### BACKGROUND OF INVENTION

Field of the Invention

The present invention relates to a magnetic member and its manufacturing method, more particularly to a magnetic member and its manufacturing method in which surface mounting technique is applied in its manufacturing process.

Brief Description of Prior Art

Generally, the so called passive magnetic member such as transformer, inductor, choke coil etc. has the feature of generating magnetic field upon inflow the electric current. Taking inductor as an example, it is constructed by a core and a coil. The magnetic element is also a key component in current various electronic information devices, for example, the magnetic element is widely used in simulation circuit and signal processing process. Referring to FIG. 1, a magnetic member 10 is shown, wherein at least one magnetic element 101 is mounted on a substrate 102 or a cover body 103, and the pins of the magnetic element 101 are electrically connected to a plurality of terminals 105 through a metal connecting wire 104, and then a power source is connected to the magnetic element 101 through each of the terminals 105 so that the magnetic element 101 generates electromagnetic induction action. However, in the process of manufacturing magnetic member 10, the pins of the magnetic element 101 is soldered to each of the terminals 105 through metallic connecting wire 104 by either manual way or complicated automatic processing equipment. Furthermore, in order that the metallic connecting wire 104 can be tightly fixed to each of the terminals 105, the metallic connecting wire 104 is further wound around each of the terminals 105 firstly and then soldering is conducted in conventional practice. However, as it needs more time to handle the soldering operation of the metallic connecting wire 104, this practice is hard to meet the requirement of speed-up of the process. Therefore, how to simplify and speed-up the assembly process of magnetic member does a problem need to be solved urgently.

### SUMMARY OF THE INVENTION

In view of the above problems and demands, the main object of the present invention is to provide a magnetic member and manufacturing method of the same, which is easily implemented in automated manufacturing process.

In order to achieve above object, the magnetic member and its manufacturing method of the present invention comprises a substrate, a circuit board, a magnetic element and a cover body, wherein the magnetic element is electrically connected to the circuit board by surface mount technique. Therefore, not only the complexity of the structure of automation machinery in an automated manufacturing process can be reduced by employing the magnetic element of the present invention, but also the soldering operation of the magnetic element on the circuit board can be significantly accelerated. Therefore, the present invention has the advantages of reducing occurrence of wire break. Furthermore, it is beneficial not only to slim type design of the magnetic member but also to the acceleration of soldering speed of the magnetic element.

### BRIEF DESCRIPTION OF THE DRAWINGS

FIG. 1 is a schematic view of a magnetic member of prior art;

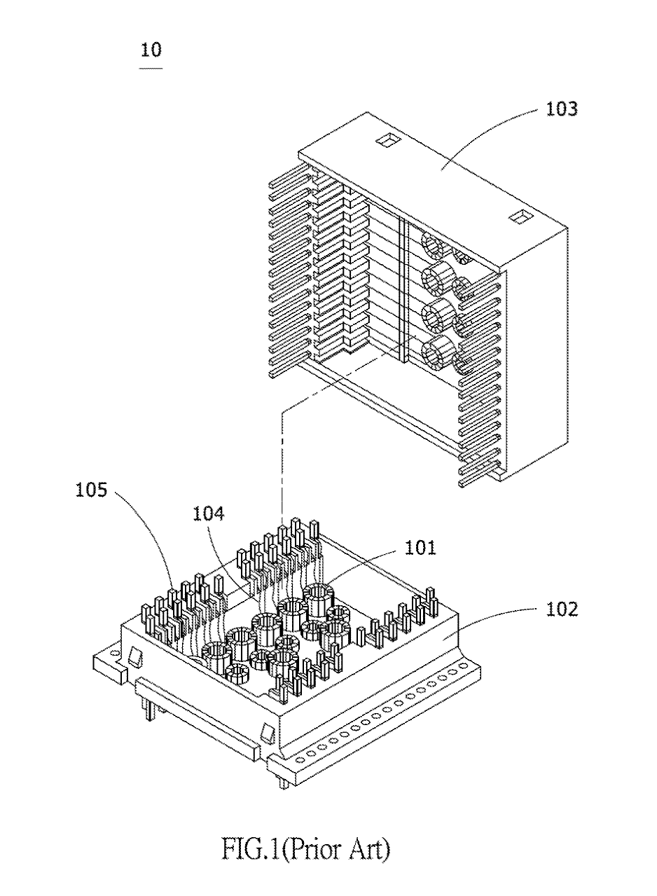

FIG. 2 is a perspective schematic view of the magnetic member according to the present invention;

FIG. 3 is a schematic view of the assembly of the present invention;

FIG. 4 is a schematic view (I) of the assembly of the present invention;

FIG. 5 is a schematic view (II) of the assembly of the present invention;

FIG. 6 is a schematic view (III) of the assembly of the present invention;

FIG. 7 is a schematic view (IV) of the assembly of the present invention;

FIG. 8 is a schematic view (V) of the assembly of the present invention;

FIG. 9 is a flow chart showing the implementation of the present invention.

### DETAILED DESCRIPTION OF PREFERRED EMBODIMENTS

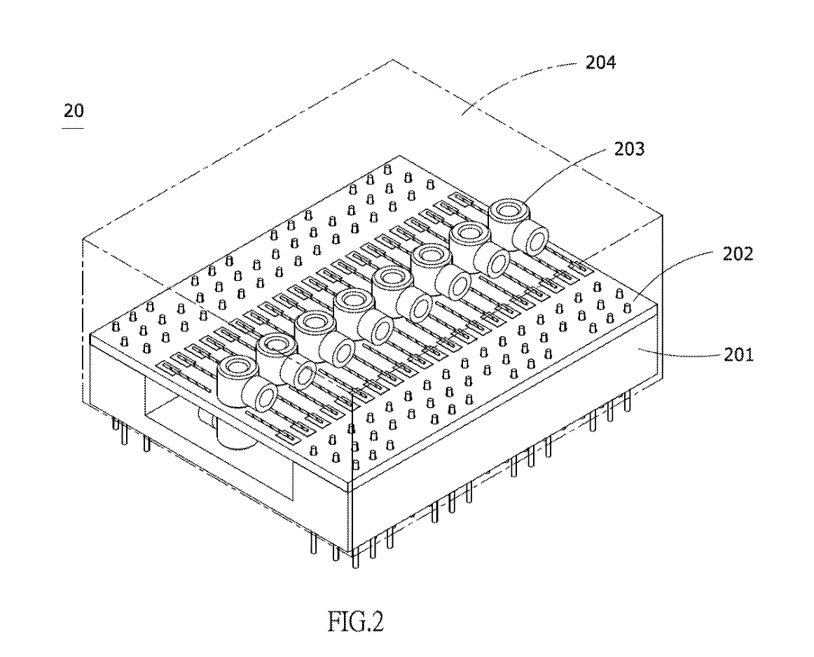

Referring to FIG. 2, the magnetic member 20 of the present invention is mainly constructed by a substrate 201, a circuit board 202, at least one magnetic element 203 and a cover body 204. As shown in the figure, the cover body 204 in normal state covers on the substrate 201 so that the circuit board 202 and the magnetic element 203 can be accommodated in the interior of the cover body 204 so as to be protected thereby. Furthermore, the magnetic element 203 is soldered on the circuit board 202 by surface mount technique (SMT) so that the magnetic element 203 in the manufacturing process of magnetic member 20 can be electrically connected with the circuit board 202 quickly. Moreover, when the magnetic member 20 is disposed on an external circuit board, the circuit board 202 can be subjected to electrically conduction, thereby each magnetic element 203 can performs electromagnetic induction action.

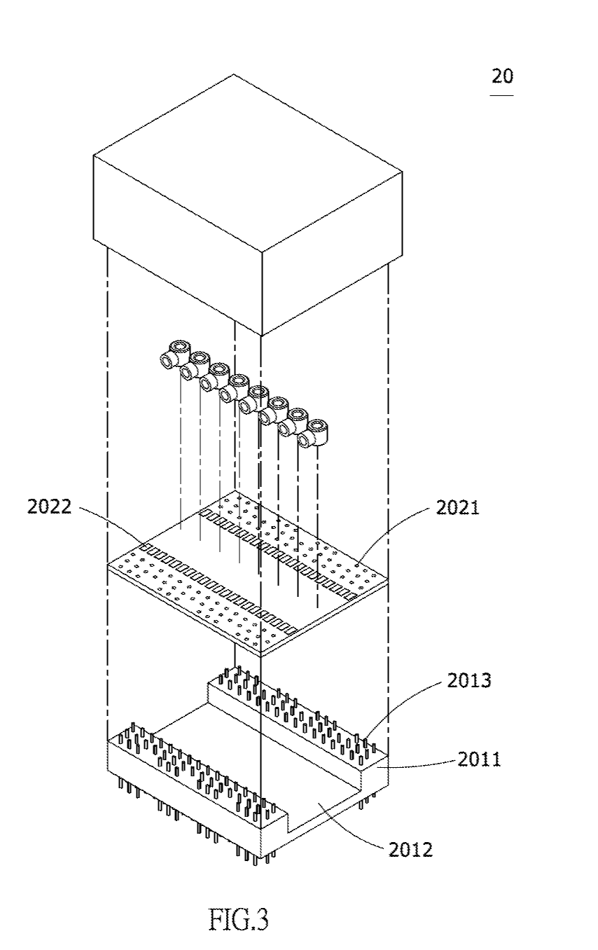

Referring to FIG. 3, the substrate 201 has retaining walls 2011 formed to be extending on both sides thereof, and a recess section 2012 is formed between the two retaining walls 2011. Each of the retaining walls 2011 is provided with a plurality of pins 2013 thereon, and each pin 2013 has its both ends exposed on both end faces of the associated retaining wall 2011. The depth of the recess section 2012 is slightly greater than the height of the magnetic element 203 electrically assembled on the circuit board 202. The circuit board 202 has circuit layout provided thereon, and the circuit board 202 mainly has a plurality of electrical connection holes 2021. Furthermore, the circuit board 202 has at least a pair of electrical contacts 2022 oppositely arranged on the surface thereof, and each pair of the electrical contacts 2022 are electrically connected with adjacent electrical connection holes 2021 respectively. The magnetic element 203, such as annular shape inductor, generates electromagnetic induction action after electrical conduction, and the cover body 204 is slightly larger than the substrate 201 so that the cover body 201 can overlie the substrate 201 so as to protect the substrate 201 and the circuit of the circuit board 202.

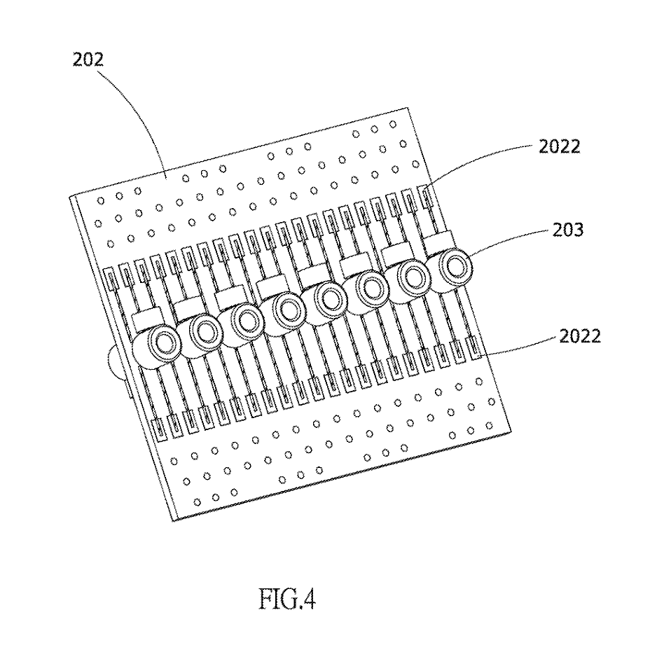

Referring to FIG. 4 and FIG. 3 too, during the assembly operation of the present invention, the pins of the magnetic element 203 are electrically connected with corresponding electrical contacts 2022 respectively by surface mount technique so that the circuit board 202 and the magnetic element 203 are in electrical connection state. It is noted that the magnetic element 203 can be disposed on the circuit board 202 according to need. In the present embodiment, the magnetic elements 203 are arranged on both sides of the circuit board 202. In the other embodiment, the magnetic elements 203 can also be disposed on the same side of the circuit board 202.

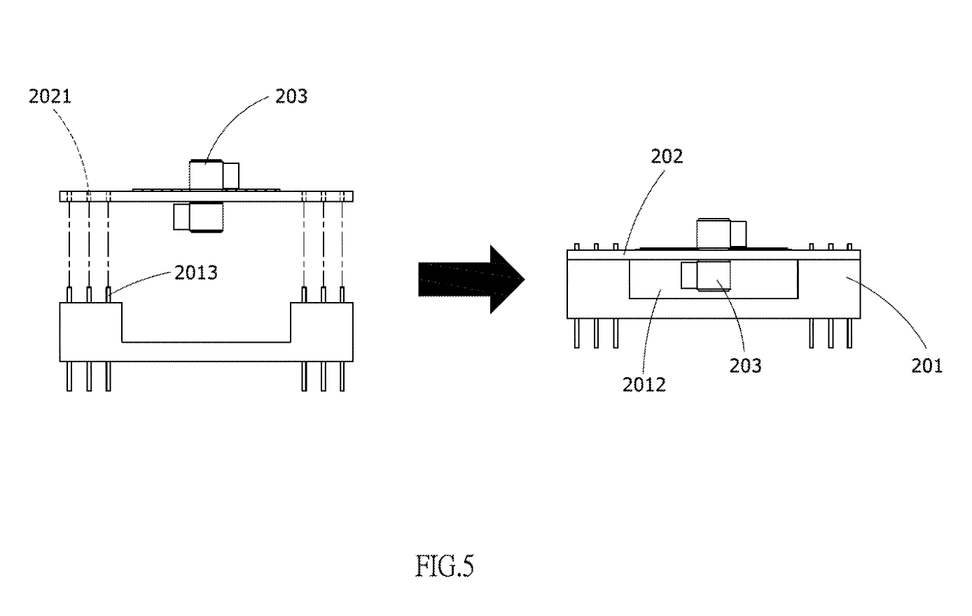

Referring to FIG. 5, after the circuit board 202 and the magnetic element 203 are in electrical connection state, the substrate 201 is assembled relatively on the circuit board 202 in such a manner that the terminals 2013 on both sides of the substrate 201 can be electrically connected to the corresponding electrical connection holes 2021 on both sides of the circuit board 202, in turn, each of the terminals 2013 can be electrically connected to the corresponding pin of the magnetic element 203 through each of the electrical connection holes 2021. As the recess section 2012 of the substrate 201 corresponds to the magnetic element 203 arranged on the bottom of the circuit board 202, the magnetic element 203 can be accommodated in the recess section 2012 after the assembly of the substrate 201 and the circuit board 202 is finished. In this manner can prevent the assembly of the substrate 201 from being hindered by the magnetic element 203 arranged on the bottom of the circuit board 202.

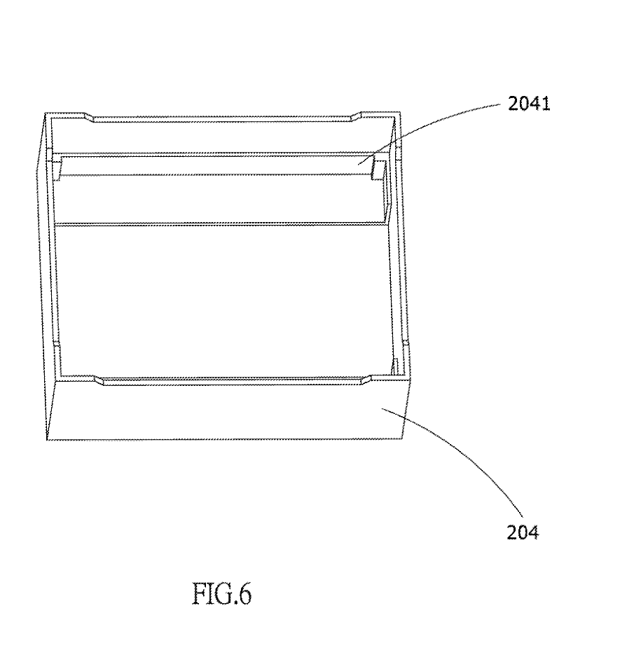

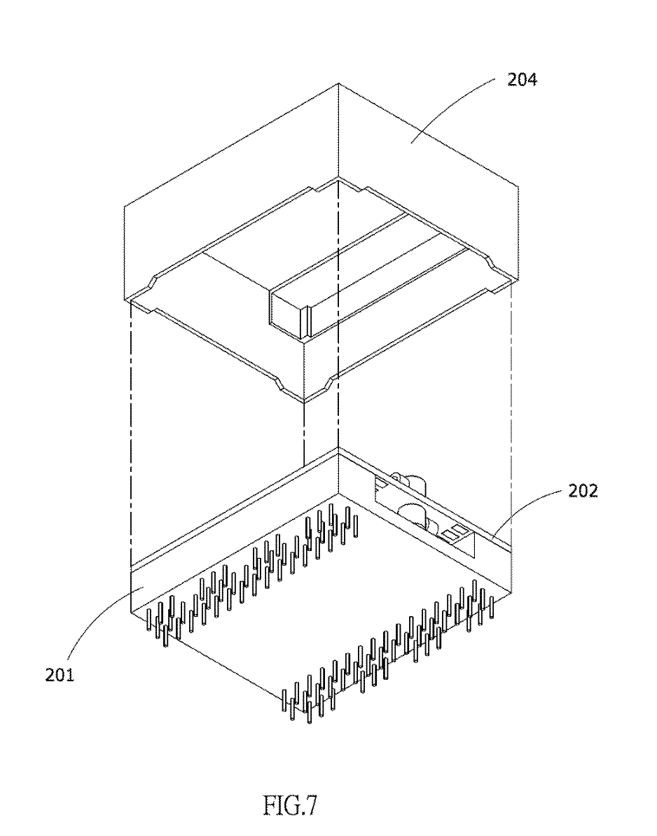

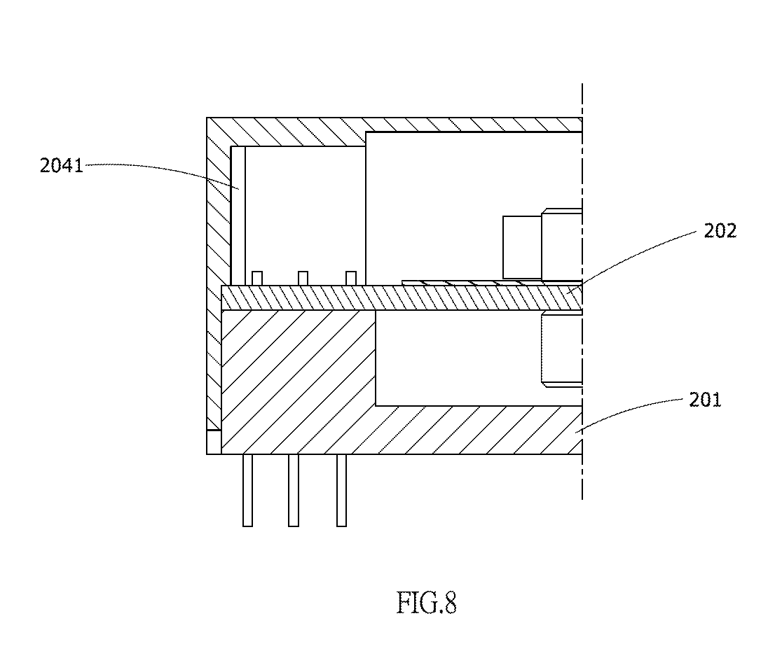

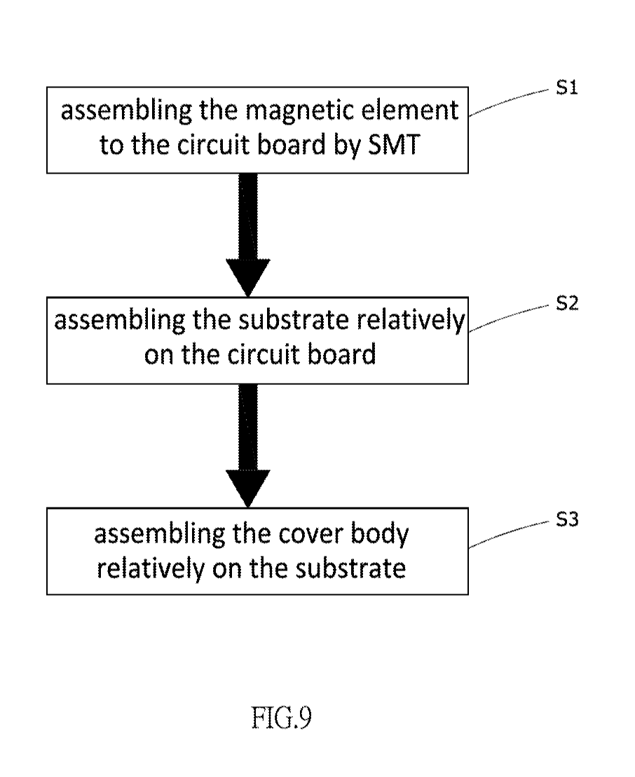

Referring to FIGS. 6 to 8, a boss 2041 is formed and extended along the inner wall surface of the bottom of the cover body 204, the height of the boss 2041 is slightly greater than that of the magnetic element 203. When the assembly of the substrate 201 and the circuit board 202 is finished, the cover body 204 is assembled on the substrate 201 to overlie the substrate 201 and the circuit board 202 so as to protect the circuit on the circuit board 202 and the magnetic element 203. When the cover body 204 is assembled on the substrate 201, the boss 2041 of the cover body 204 will abut against the circuit board 202 so that the circuit board 202 is limited by the boss 2041. As the height of the boss 2041 is slightly greater that of the magnetic element 203, the magnetic element 203 of the circuit board 202 can be accommodated in the cover body 204 after the assembly of the substrate 201 and the cover body 204 is finished. In this way, the assembly is not hindered. Furthermore, before the cover body 204 is assembled on the substrate 201, both sides of the surface of the circuit board 202 can be coated with a resin layer so as to protect the circuit of the circuit board 202. Referring to FIG. 9, the flow chart (steps) of manufacturing the magnetic member 20 will be described as below.
(1) S1: Assembling the magnetic element to the circuit board by SMT. Each of the pins of at least one magnetic element 203 is soldered quickly to a pair of electrical contacts 2022 oppositely arranged to each other by surface mount technique so that the circuit board 202 and each magnetic element 203 are in electrical connection state;
(2) S2: Assembling the substrate relatively on the circuit board. The terminals 2013 on both sides of the substrate 201 are corresponded to a plurality of electrical connection holes 2021 of the circuit board 202, and then the terminals 2013 are electrically connected to corresponding electrical connection holes 2021 respectively so that each of the terminals 2013 can be electrically connected with corresponding pin of the magnetic element 203 through corresponding electrical connection hole 2021;
(3) S3: Assembling the cover body relatively on the substrate. When the assembly of the substrate 201 and the circuit board 202 is completed, the cover body 204 is assembled on the substrate 201. In the process of assembly, a boss 2041 on the bottom of the cover body 204 has limiting function on the substrate 201 and the circuit board 202, so the magnetic elements 203 on the surface of the circuit board 202 can be accommodated in the cover body 204 as to protect the substrate 201 and the circuit board 202.

Based on foregoing, the magnetic member and its manufacturing method of the present invention comprises a substrate, a circuit board, a magnetic element and a cover body, wherein the magnetic element is electrically connected to a pair of electrical contacts arranged opposite to each other on the circuit board by surface mount technique. When the electric connection between a plurality of terminals on the substrate and a plurality of electrical connection holes on the circuit board is completed, the magnetic element can finish electrical connection by the pairs of electrical contacts and corresponding terminals. The magnetic element is soldered to the circuit board by surface mount technique so as to reduce occurrence of wire break. Furthermore, it is beneficial not only to slim type design of the magnetic member but also to the acceleration of manufacturing process speed of the magnetic member. In this manner, if the present invention is implemented according to the above description, the object of providing a magnetic member, which is easily to be implemented in automated manufacturing process, can be ensured.

While the present invention has been described by preferred embodiment in conjunction with accompanying drawings, it should be understood that the embodiments and the drawings are merely for descriptive and illustrative purpose, not intended for restriction of the scope of the present invention. Equivalent variations and modifications conducted by person skilled in the art without departing from the spirit and scope of the present invention should be considered to be still within the scope of the present invention.

What is claimed is:

1. A magnetic member, comprising:
a substrate having retaining walls formed to extend on both sides thereof, a recess section being formed between said two retaining walls; each of said retaining walls being provided with a plurality of pins thereon, and each said pin having its both ends exposed on both ends of the associated retaining wall;
.a circuit board having a plurality of electrical connection holes each of which is electrically connected to a corresponding terminal;
said circuit board having a pair of electrical contacts arranged opposite to each other, each of said electrical contacts being electrically connected to adjacent said electrical connection hole;
at least one magnetic element disposed on said circuit board, said magnetic element being electrically connected with said pair of electrical contacts;
a cover body assembled relatively on said substrate in such a manner that said cover body can cover on said circuit board.

2. The magnetic member as claimed in claim 1, wherein the depth of said recess section is larger than the height of said magnetic element.

3. The magnetic member as claimed in claim 1, wherein said magnetic element is electrically connected to said circuit board by surface mount technique.

4. The magnetic member as claimed in claim 1, wherein said cover body has at least one boss formed and extended along the inner wall surface of the bottom of said cover body, and said substrate and said circuit board are limited by said boss.

5. The magnetic member as claimed in claim 1, wherein the height of said boss is larger than that of said magnetic element.

6. The magnetic member as claimed in claim 1, wherein said circuit board is coated with a resin layer.

7. The magnetic member as claimed in claim 1, wherein said circuit board has its two faces assembled with said magnetic element.

8. A manufacturing method of magnetic member, comprising the steps of:
assembling a magnetic element to a circuit board by SMT:
each of pins of at least one magnetic element is soldered to a pair of electrical contacts oppositely arranged to each other by surface mount technique so that said circuit board and each said magnetic element are in electrical connection state;
assembling a substrate relatively on said circuit board:
the terminals on both sides of said substrate are corresponded to a plurality of electrical connection holes of said circuit board, and then said terminals are electrically connected to corresponding electrical connection holes respectively so that each of said terminals can be electrically connected with corresponding pin of said magnetic element through corresponding electrical connection hole; and
assembling a cover body relatively on said substrate:
when the assembly of said substrate and said circuit board is completed, said cover body is assembled on said substrate so as to protect said substrate and said circuit board.

9. The manufacturing method of magnetic member as claimed in claim 8, wherein a boss on the bottom of said cover body has limiting action on said substrate and said circuit board in such a manner that said magnetic element on the surface of said circuit board can be accommodated in said cover body.

10. The manufacturing method of magnetic member as claimed in claim 9, wherein the height of said boss is larger than that of said magnetic element.

11. The manufacturing method of magnetic member as claimed in claim 8, wherein said circuit board is coated with a resin layer.

12. The manufacturing method of magnetic member as claimed in claim 8, wherein said circuit board has its two faces assembled with said magnetic element.
